(19) United States
(12) Patent Application Publication
(10) Pub. No.: US 2015/0128803 A1
(43) Pub. Date: May 14, 2015

(54) Assembly and Method for a Bag Filter

(71) Applicant: BHA Altair, LLC, Franklin, TN (US)

(72) Inventors: Etienne Rene Pascal Jarrier, Alton (GB); Stephen David Hiner, Alton (GB)

(73) Assignee: BHA Altair, LLC, Franklin, TN (US)

(21) Appl. No.: 14/076,290

(22) Filed: Nov. 11, 2013

(51) Int. Cl. F02M 35/024; B01D 46/00

(52) U.S. Cl. CPC F02M 35/02458; B01D 46/003
USPC 95/287; 55/486; 55/361; 55/487

(57) ABSTRACT

The present application provides a filtration unit for filtering a flow. The filtration unit may include one or more first layers and a second layer. The one or more first layers may include a prefilter layer and a wave layer.

### TECHNICAL FIELD

The present application and the resultant patent relate generally to gas turbine engines and more particularly relate to a filter media for use with a filtration unit such as a bag filter and the like with improved filtration efficiency and with a reduced pressure drop thereacross.

### BACKGROUND OF THE INVENTION

Power generation equipment, such as a gas turbine engine and the like, generally uses a large supply of intake air to support the combustion process. Various types of inlet air filtration systems thus may be used upstream of the gas turbine compressor air inlet and elsewhere. Impure air laden with dust particles, salts, and other contaminants may cause damage to the compressor blades, other types of compressor components, and other components of the gas turbine engine in general. Contaminates may cause damage via corrosion, erosion, and the like. Such damage may reduce the life expectancy and performance of the compressor and also reduce the overall efficiency of the gas turbine engine. To avoid these problems, the inlet airflow generally passes through a series of filters and screens to assist in removing the contaminants before they reach the compressor or elsewhere.

Such filtration units may include a bag filter and the like. Dust and other types of particulate matter may be captured on the surface of the filter media in the bag filters. Such bag filters, however, may have a relatively high airflow rate therethrough with a high differential pressure loss. Such high airflow rates and differential pressure losses may result in the entrapment of less dust and other types of particulate matter. Moreover, such conditions may result in an overall shorter bag filter life with possibly reduced efficiency.

There is thus a desire for an improved inlet air filtration system for use with a compressor and similar types of components in a gas turbine engine. Such an improved inlet air filtration system may provide a bag filter and the like with high filtration efficiency and with a reduced pressure loss therethrough with at least one filter layer.

### SUMMARY OF THE INVENTION

The present application and the resultant patent thus provide a filtration unit for filtering a flow. The filtration unit may include one or more first layers and a second layer. The one or more first layers may include a prefilter layer combined with a wave layer.

The present application and the resultant patent further provide a method of filtering a flow. The method may include the steps of combining a wave layer with a prefilter layer, positioning the combined layer about a sidewall of a filtration unit, filtering a number of first particulates and a number of droplets with the prefilter layer, and filtering a number of second particulates with the wave layer. The method further may include the step of positioning the combined layer on a support layer and the step of coalescing the droplets.

The present application and the resultant patent further provide a filtration unit for filtering a flow of air for a gas turbine engine. The filtration unit may include one or more first layers and a support layer. The one or more first layers may include a coalescing/prefilter layer and a high efficiency wave layer. The high efficiency wave layer may have a curvilinear shape.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine with a compressor, combustor, a turbine, a shaft, and a load. An inlet air filtration system is positioned about the compressor.

FIG. 2 is a perspective view of an example of a bag filter with a number of filter pockets as may be described herein.

FIG. 3 is a sectional view of a sidewall of a filter pocket of the bag filter of FIG. 2.

### DETAILED DESCRIPTION

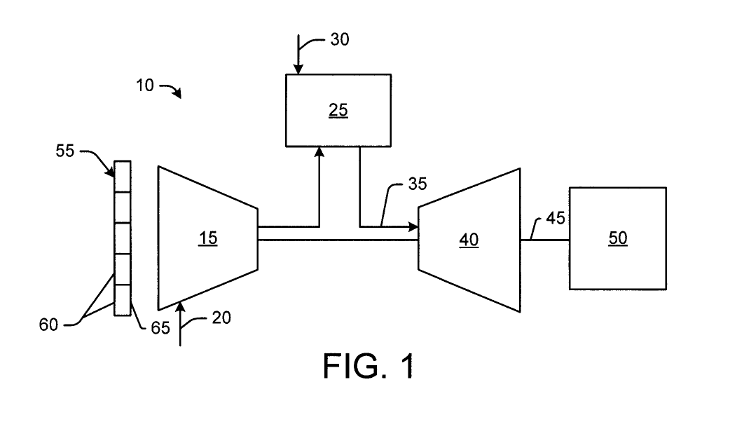

Referring now to the drawings, in which like numerals refer to like elements throughout the several views, FIG. 1 shows a schematic view of gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a pressurized flow of fuel 30 and ignites the mixture to create a flow of combustion gases 35. Although only a single combustor 25 is shown, the gas turbine engine 10 may include any number of combustors 25. The flow of combustion gases 35 is in turn delivered to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, liquid fuels, various types of syngas, and/or other types of fuels or blends thereof The gas turbine engine 10 may be any one of a number of different gas turbine engines offered by General Electric Company of Schenectady, N.Y., including, but not limited to, those such as a 7 or a 9 series heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

The gas turbine engine 10 also may be used with a filtration system 55. The filtration system 55 may include any number of filtration units 60 positioned therein. The filtration system 55 may be positioned upstream of the compressor 15 so as to filter the incoming flow of air 20 with respect to particulate contaminates and/or water droplets. The filtration system 55 may be configured as a filter house or other type of structure. In this example, the filtration units 60 may be in the form of a number of “bag”-type or pocket filters 65 and the like. Such bag filters 65 may have a generally square, planar configuration. Other types of filters and other configurations also may be known. Differing types of filter media also may be used herein.

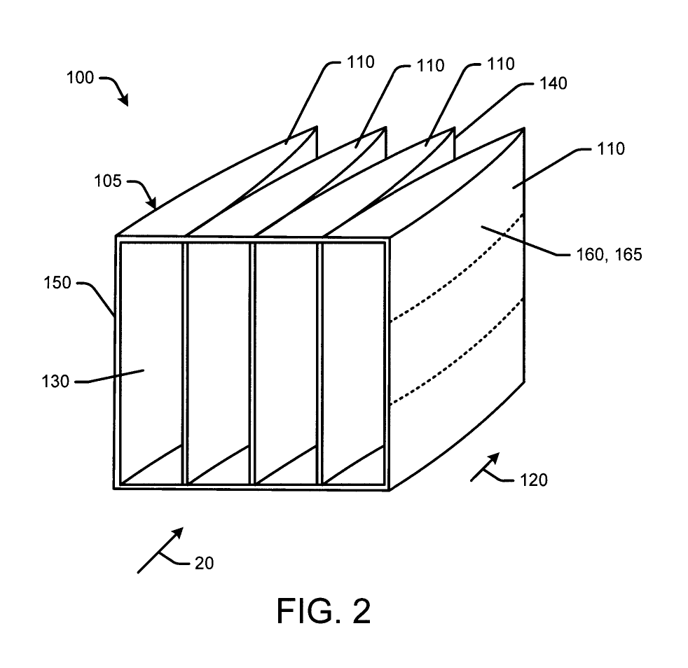

FIG. 2 shows an example of a filtration unit 100 as may be described herein. The filtration unit 100 may include a bag filter 105 formed with at least one filter pocket 110 therein. The flow of air 20 to the compressor 15 or elsewhere may flow through the filtration unit 100 generally along a flow direction 120. The flow of air 20 may be received at an open end 130 and may proceed along the flow direction 120 towards a closed end 140 of each filter pocket 110. In addition to the flow of air 20 to the compressor 15 or elsewhere, the filtration unit 100 also may be used to filter any type of fluid therethrough. The fluid may be in a gaseous or a liquid form and/or combinations thereof.

Although four (4) filter pockets 110 are shown, the filtration unit 100 may include any number of the filter pockets 110 in any size, shape, or configuration. The respective filter pockets 110 may have the same or different sizes, shapes, or configurations. The filtration units 100 may be used in a filter house with a number of filters for filtering particulates such as dust and other particulate matter and/or water droplets from the flow of air 20. Moreover, the filtration units 100 may be used as a prefilter or as a final filter.

The filtration units 100 may include an outer frame 150. The outer frame 150 may have any size, shape, or configuration. The outer frame 150 may be configured to receive any number of the filter pockets 110 therein. The open end 130 of the filter pocket 110 may be configured to fit within the area bounded by the frame 150. Other configurations and other components may be used herein.

The filter pockets 110 may include a number of sidewall 160 formed of a filter material 165. The filter material 165 may include any number of materials and may be formed by a variety of processes. Filter pockets 110 of different filter materials 165 also may be used herein. The nature of the filter material 165 may vary with ambient conditions, intended loads, or other types of operational parameters.

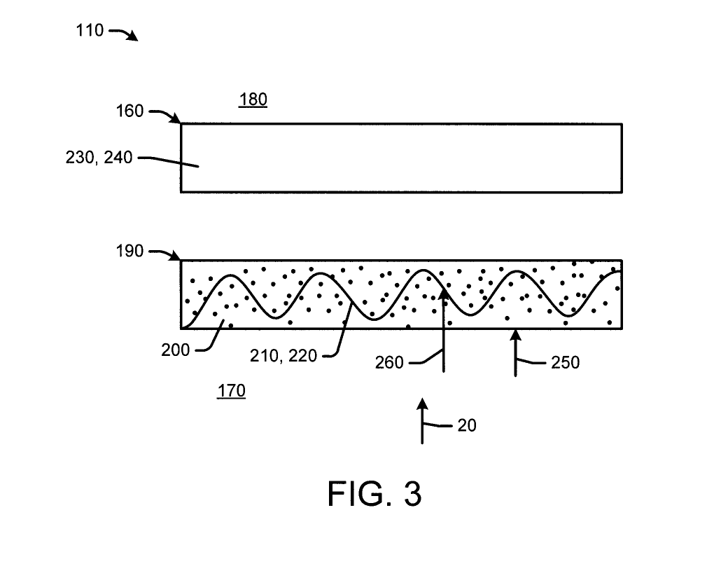

FIG. 3 shows an example of one of the sidewalls 160 of the filter pocket 110. The sidewall 160 may separate an inlet side 170 and an outlet side 180. The flow of air 20 may flow along the flow direction 120 from the inlet side 170 to the outlet side 180. In this example, the sidewall 160 may include one or more first layers 190. The first layers 190 may include any number of materials to filter the flow of air 20. Specifically, the first layer 190 may include a coalescing/prefilter layer 200 that is combined with a high efficiency wave layer 210 to form a combined first layer 190. In use, only one first layer 190 may be required in the sidewall 160 although any number may be used herein.

The coalescing/prefilter layer 200 may be a non-woven such as an air laid high loft or a woven such as a knit mesh. More specifically, the coalescing/prefilter layer 200 may be made out of a polyester, a polypropylene, a glass fiber, and/or a natural fiber such as cotton, coconut, and the like, and/or combinations thereof. Other types of filtering materials may be used herein. The coalescing/prefilter layer 200 may have any desired thickness or orientation. More than one coalescing/prefilter layer 200 may be used herein. The coalescing/prefilter layer 200 may filter and drain, for example, liquid such as water droplets and the like as well as relatively larger particulates in the flow of air 20.

The high efficiency wave layer 210 may be a non-woven such as a spun bond, melt blow, wet laid, ePTFE membrane (expanded polytetrafluoroethylene), and the like. A woven also may be used. More specifically, the high efficiency wave layer 210 may be made from a polyester, a polypropylene, a PTFE, a glass fiber, and the like, and/or combinations thereof. Other types of filtering materials may be used herein. The high efficiency wave layer 210 may have any desired thickness or orientation. More than one high efficiency wave layer 210 may be used herein. The high efficiency wave layer 210 may filter, for example, relatively finer particulates as compared to the coalescing/prefilter layer 200. The high efficiency wave layer 210 may be held in a wave-like or curvilinear configuration 220. Such a curvilinear configuration 220 thus may provide an increased surface area for improved filtration efficiency and a reduced pressure loss thereacross. Other components and other configurations may be used herein.

The sidewall 160 also may include one or more optional second layers 230. The second layer 230 may include a support material such that the second layer 230 may function as a support layer 240 for the first layers 190. The support layer 240 may be a non-woven such as a spun bond or needle felt or a woven such as a mesh or a knit mesh. More specifically, the support layer 240 may be made from a polyester, a polypropylene, and the like, and/or combinations thereof. The support layer 240 may have any desired thickness or orientation. More than one support layer 240 may be used herein. The support layer 240 may be generally open so as to reduce the pressure loss of the flow of air 20 flowing therethrough. The support layer 240 may be on either or both sides of the first layers 190. Other components and other configurations may be used herein.

In use, the first layers 190 of the sidewall 160 may filter relatively larger particulates and water droplets via the coalescing/prefilter layer 200. The particulates may remain on the surface of the coalescing/prefilter layer 200. In the case of liquid or water droplets, the liquid then may accumulate on the surface and/or coalesce through a depth of the filter media. The liquid droplets may coalesce so as to increase in size and weight. Once the liquid droplets have coalesced to a certain size and weight, the droplets may fall and drain from the coalescing/prefilter layer 200 by gravity or otherwise. These larger droplets should drain from the sidewall 160 and prevent finer droplets from reaching the high efficiency wave layer 210. As such, the amount of the particulates and droplets that may accumulate on the surface of the coalescing/prefilter layer 200 may be limited so as to reduce the overall pressure loss of the flow of air 20 flowing therethrough. Moreover, having the water droplets coalesce and drain before reaching the high efficiency wave layer 210 may reduce the overall pressure loss in mist and fog conditions and the like.

The high efficiency wave layer 210 of the first layer 190 may filter out generally smaller particulates. The smaller particulates may have passed through the coalescing/prefilter layer 200 and may include particulates such as salt, sand, dust, and other types of contaminates. The use of the curvilinear configuration 220 for the high efficiency wave layer 210 provides an increased surface area for improved filtration efficiency with a reduced pressure loss therethrough. Specifically, the smaller particulates may remain on the surface of the high efficiency wave layer 210 and then may fall and/or be removed therefrom so as to limit the pressure loss therethrough. The flow of air 20 then may continue through the second layer 230 as a filtered air flow into the compressor 15 or elsewhere.

The flow of air 20 thus is filtered as the flow passes through the first layers 190. Specifically, a first group of particulates and droplets 250 may be filtered via the coalescing/prefilter layer 200 while a second group of particulates 260 may be filtered via the high efficiency wave layer 210. The second group of particulates 260 may be relatively smaller than the first group 250. Other types of particulates and other types of contaminates may be filtered herein. Moreover, the droplets may coalesce and drain before reaching the high efficiency wave layer 210. Given such, the flow of air exiting the second layer 230 thus may be a filtered airflow appropriate for use in the compressor 15 or elsewhere in a clean and efficient manner. The filter pocket 110 thus provides increased filtration efficiency with a reduced pressure loss therethrough. Other components and other configurations may be used herein.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

1. A filtration unit for filtering a flow, comprising:
one or more first layers;
the one or more first layers comprise a prefilter layer; and
the one or more first layers comprise a wave layer; and
a second layer.

2. The filtration unit of claim 1, wherein the filtration unit comprises a bag filter.

3. The filtration unit of claim 1, wherein the filtration unit comprises a pocket filter.

4. The filtration unit of claim 1, wherein the filtration unit comprises a sidewall.

5. The filtration unit of claim 1, wherein the filtration unit comprises an outer frame.

6. The filtration unit of claim 1, wherein the prefilter layer comprises a coalescing layer.

7. The filtration unit of claim 1, wherein the prefilter layer comprises a polyester, a polypropylene, a glass fiber, and/or a natural fiber.

8. The filtration unit of claim 1, wherein the wave layer comprises a high efficiency wave layer.

9. The filtration unit of claim 1, wherein the wave layer comprises a curvilinear shape.

10. The filtration unit of claim 1, wherein the wave layer comprises a polyester, a polypropylene, a polytetrafluoroethylene, and/or a glass fiber.

11. The filtration unit of claim 1, wherein the wave layer is combined with the prefilter layer.

12. The filtration unit of claim 1, wherein the second layer comprises a support layer.

13. The filtration unit of claim 1, wherein the second layer comprises a polyester or a polypropylene.

14. The filtration unit of claim 1, wherein the prefilter layer filters a plurality of first particulates and the wave layer filters a plurality of smaller second particulates.

15. A method of filtering a flow, comprising:
combining a wave layer with a prefilter layer;
positioning the combined layer about a sidewall of a filtration unit;
filtering a plurality of first particulates and a plurality of droplets with the prefilter layer; and
filtering a plurality of second particulates with the wave layer.

16. The method of claim 15, further comprising the step of positioning the combined layer on a support layer.

17. The method of claim 15, wherein the step of filtering a plurality of
droplets with the prefilter layer comprises filtering and coalescing the plurality of droplets so as to reduce the pressure loss thereacross.

18. A filtration unit for filtering a flow of air for a gas turbine engine, comprising:
one or more first layers;
the one or more first layers comprise a coalescing/prefilter layer; and
the one or more first layers comprise a high efficiency wave layer; and
a support layer.

19. The filtration unit of claim 18, wherein the coalescing/prefilter layer comprises a polyester, a polypropylene, a glass fiber, and/or a natural fiber.

20. The filtration unit of claim 18, wherein the high efficiency wave layer comprises a polyester, a polypropylene, a polytetrafluoroethylene, and/or a glass fiber with a curvilinear shape.
